(19) United States
(12) Patent Application Publication
(10) Pub. No.: US 2024/0428046 A1
(43) Pub. Date: Dec. 26, 2024

(54) Methods And Apparatus For Managing Weight Data Accesses For Neural Network Processors

(71) Applicant: Expedera, Inc., Palo Alto, CA (US)

(72) Inventors: Sharad Vasantrao Chole, San Jose, CA (US); Shang-Tse Chuang, Los Altos, CA (US); Siyad Chih-Hua Ma, Palo Alto, CA (US)

(21) Appl. No.: 18/212,618

(22) Filed: Jun. 21, 2023

(51) Int. Cl. G06N 3/04

(52) U.S. Cl. CPC G06N 3/04

(57) ABSTRACT

Artificial intelligence is an increasingly important sector of the computer industry. However, artificial intelligence is extremely computationally intensive field such that it can be expensive, time consuming, and energy consuming. Fortunately, many of the calculations required for artificial intelligence can be performed in parallel such that specialized processors can great increase computational performance. Specifically, artificial intelligence generally requires large numbers of matrix operations to implement neural networks such that specialized matrix processor circuits can improve performance. To perform all these matrix operations, the neural processing circuits must be quickly and efficiently supplied with data to process or else the matrix processor circuits end up idle or spending large amounts of time loading weight matrix data. Thus, this document discloses apparatus and methods for efficiently operating external interfaces to storage on matrix processor circuits that minimize latency and maximize interface utilization when accessing weight matrix data.

### TECHNICAL FIELD

The present invention relates to the field of digital processing circuits. In particular, but not by way of limitation, the present invention discloses digital circuit designs, control systems, and operating modes for managing on and off-chip weight matrix data accesses for digital circuits that perform neural network processing operations.

### BACKGROUND

Computer system designers are always attempting to design faster and faster computer systems. Faster computer systems allow for extremely complex computational models such as weather prediction, protein-folding, celestial mechanics, artificial intelligence, and complex three-dimensional video renderings to be performed faster. Furthermore, the computational models being simulated can be made every more detailed thus rendering ever more accurate results.

To design faster computers systems, many different techniques are used. One of the simplest techniques is to increase the clock speed at which computer systems operate although it is becoming much more difficult to increase the clock speed due to the physics of current transistor materials. Processing ever wider data structures can also increase computer performance, but this only helps for certain types of computational tasks that can take advantage of wider data structures. Two of the current popular technique of improving processing speeds is to use parallel processing techniques such as implementing multiple computational cores within a computer processor or combining thousands of different computer systems on a network to cooperate on a single computational problem.

One of the fields most in need of specialized processors to improve performance is the field of Artificial Intelligence (AI). Artificial Intelligence is increasingly being used for a wide variety of complex tasks such as image recognition, High-Performance Computing (HPC), scientific computing, machine learning, data mining, speech recognition, and self-driving vehicles. Artificial Intelligence applications tend to rely very heavily upon matrix calculations from the mathematical field of linear algebra. Specifically, matrix operations are generally needed to implement artificial neural networks (ANNs) that learn from a set of training data and then store that learning in the form of neural network weight values. The neural network can then later apply that learning stored within the neural network weight values to new input data to make logical inferences about that new input data.

Due to the very heavy usage of matrix computations in neural networks, artificial intelligence is a computationally intensive field of computing desperately in need of computational optimizations. One of the most popular techniques to improve artificial intelligence application performance is to create specialized processing circuits for the performing matrix operations needed to implement a neural network. Specialized matrix processors take advantage of the parallelism inherent in matrix operations and thus efficiently execute the matrix calculations commonly used in artificial intelligence.

Artificial Intelligence processing systems perform vast amounts of linear algebra matrix calculations. The matrix calculations performed by artificial intelligence systems are often performed repeatedly with the same set of matrix weights but different input data vectors. Similarly, a data vector may need to be processed through several neural network layers requiring many matrix calculations that generate many intermediate results before calculating a final output result.

All these complex matrix calculations required for neural network based artificial intelligence applications involve moving a large amount of data from memory storage and then into and out of the specialized neural network processing circuits. In particular, neural network matrix processing operations require large weight matrices to be loaded into matrix processing circuits. The memory access operations for the large weight matrices needed for neural networks can consume a significant amount of electricity, consume significant amounts of memory bandwidth, and cause latency. Without good coordination, all these memory access operations for the weight matrices can slow down the performance of the dedicated neural network processor. Therefore, it is desirable to develop new techniques for organizing and scheduling memory access operations for the weight matrices used within neural network processing in a manner that optimizes the usage of memory bandwidth and processor resources.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1A illustrates a conceptual diagram of a single layer artificial neural network.

FIG. 1B illustrates a conceptual diagram of a three-layer artificial neural network.

FIG. 1C illustrates a conceptual diagram of a two-layer artificial neural network that does not have dependencies between every input data vector value and every output data vector value.

FIG. 2A illustrates a block diagram of one embodiment matrix processor circuit that may be used to perform matrix calculations.

FIG. 2B illustrates a conceptual diagram of the matrix processor circuit of FIG. 2A with a four-by-four weight matrix consisting of sixteen weight value elements W[0,0] to W[3,3] stored within the SRAM memory system.

FIG. 2C illustrates a block diagram of an abstracted matrix processor circuit that may be used to perform matrix calculations.

FIG. 2D illustrates a block diagram of an abstracted matrix processor circuit with bus interfaces on all sides.

FIG. 3A illustrates a block diagram of a matrix processor array also known as a Neural Processing Unit (NPU).

FIG. 3B illustrates one embodiment of the matrix processor array of FIG. 3A.

FIG. 4 illustrates a timing diagram of conventional processing of a neural network.

FIG. 5A conceptually illustrates a nine-layer neural network that receives a set of input data, processes that input data through nine neural network layers, and outputs a set of result data.

FIG. 5B illustrates a simple timing diagram of a method of how weight matrices may be loaded into a neural processor.

FIG. 5C illustrates the timing diagram of FIG. 5B wherein work fragments allow work from multiple different neural network layers to be operated on simultaneously.

FIG. 5D illustrates a timing diagram of a method that loads weight matrices into a neural processor while maximizing neural processor utilization.

FIG. 5E illustrates a timing diagram of a method that loads weight matrices into a neural processor while maximizing neural processor utilization and reducing memory usage.

FIG. 6 illustrates a timing diagram illustrating how weight matrices may be prefetched into a neural network processor.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention. For example, although some of the example embodiments are disclosed with reference to a specific matrix processor circuit implementation, the disclosed techniques may be used with any other implementations of a matrix processor circuit. The example embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

### Neural Networks Overview

One of the core techniques in artificial intelligence (AI) is the use of artificial neural networks (ANNs). Artificial neural networks first learn from training data and then are later used to make logical inferences from new input data. Artificial neural networks were originally designed to be similar to the biological neuron networks in animal brains.

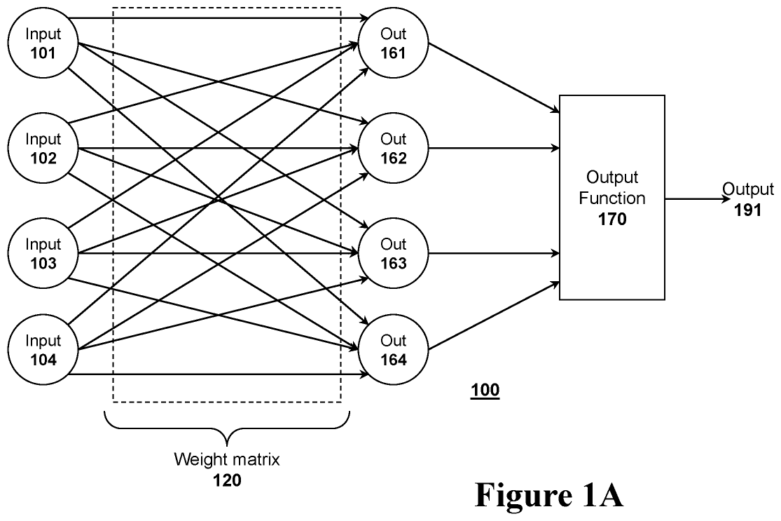

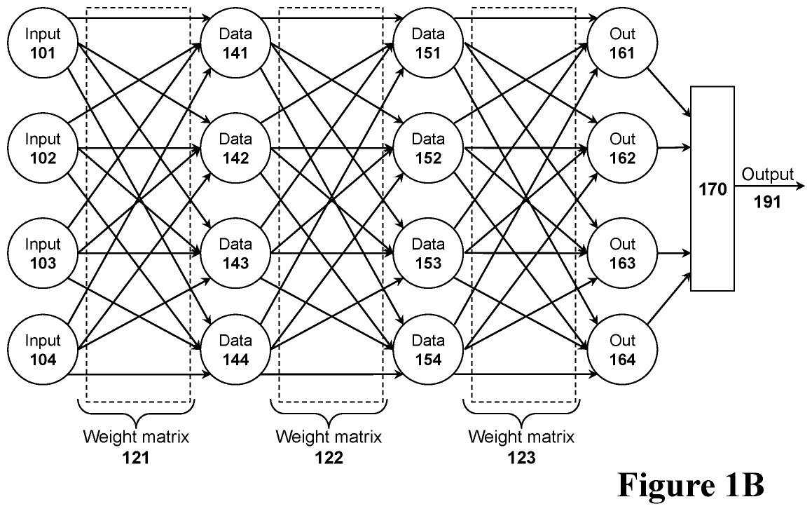

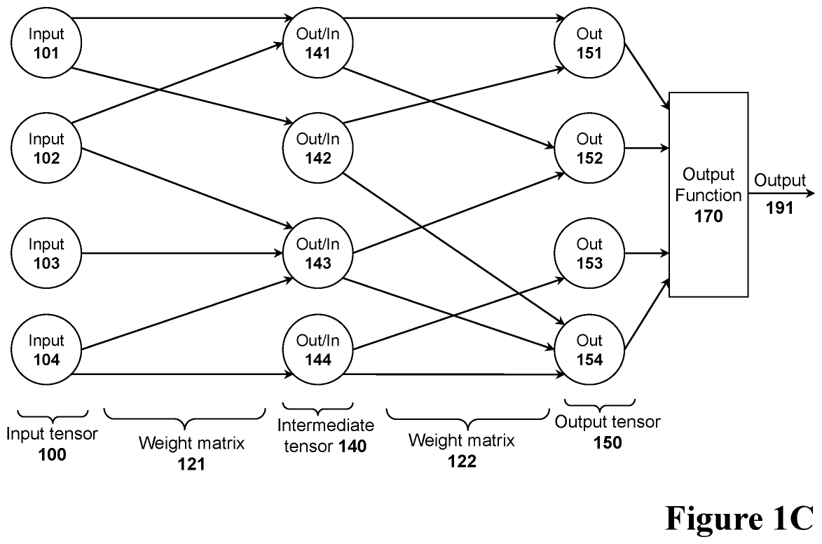

FIG. 1A illustrates a conceptual diagram of a very simple single-layer four-input artificial neural network 100. Referring to FIG. 1A, an input data vector (made up of inputs 101 to 104) are provided with training data during training sessions and then with new input data when the artificial neural network is used to make inferences. The input data vector (made up of inputs 101 to 104) are processed with weight data in a weighted matrix 120 to create an output data vector (made up of outputs 161 to 164). Many different types of data processing may be performed using weighted matrix 120 (such as a Hadamard product, Frobenius inner product, matrix addition, etc.) however this document will focus upon the well-known matrix product.

After processing the input data vector (made up of inputs 101 to 104) with the weighted matrix 120 the system creates the output data vector (made up of outputs 161 to 164). The output data vector (made up of outputs 161 to 164) may be combined with an output function 170 to create a final output 191 for the artificial neural network 100. The output function 170 may be referred to as an activation function. During training sessions, the output data may be compared with a desired target output (not shown) and the difference between the output data and the desired target output may be used to adjust the weight data within weight matrix 120 to improve the accuracy of the artificial neural network 100.

Note that the four-input artificial neural network of FIG. 1A illustrates just one example of a simple small artificial neural network 100. Artificial neural networks may be constructed much wider than just four inputs. Multiple independent artificial neural networks may be used in parallel, and the outputs of the independent artificial neural networks may be combined.

Artificial neural networks may comprise many layers of weight matrices such that very complex computational analysis of the input data may be performed. For example, FIG. 1B illustrates a three-layer artificial neural network wherein the input data vector (made up of inputs 101 to 104) is processed with a first weighted matrix 121 to create a first intermediate data vector (made up of data 141 to 144). Next, the first intermediate data vector (made up of data 141 to 144) is processed with a second weighted matrix 122 to create a second intermediate data vector (made up of data 151 to 154). Then second intermediate data vector (made up of data 151 to 154) is processed with a third weighted matrix 123 to create output data vector (made up of outputs 161 to 164). Output data vector (made up of outputs 161 to 164) may then be processed by output function 170 to create a final output 191. Alternatively (or in addition to), the output data vector (made up of outputs 161 to 164) may also be used as intermediate data that is fed into additional artificial neural network layers (not shown) such that very complex hierarchical artificial neural networks may be created.

### Parallel Operations

It is well known that due to the use of matrices, the computing operations to be performed have a significant amount of parallelism within each layer that can be exploited such that computations can be performed in parallel. Specifically, the matrix multiplication operations require many independent multiplication operations that can be performed in parallel. However, artificial neural networks can also include inherent parallelism that can be exploited between the different layers of an artificial neural network.

FIG. 1C illustrates a two-layer neural network that receives an input tensor 100, processes that input tensor 100 through a first layer with a first weight matrix 121 to create an intermediate tensor 140, and then processes that intermediate tensor 140 through a second layer with a second weight matrix 122 to create an output tensor 150. However, in the two-layer neural network of FIG. 1C, not every input data value in input tensor 100 affects ever intermediate value in intermediate tensor 140. Similarly, not every intermediate data value in intermediate tensor 140 affects ever output value in output tensor 150. Therefore, some operations in a neural network layer can be performed before all of the input values from the input tensor are ready.

For example, intermediate value 141 only depends on input data values 101 and 102. Similarly, intermediate value 142 only depends on input data value 101. Thus, intermediate values 141 and 142 can be computed before input values 103 and 104 are available yet and thus can be calculated in parallel with the computations needed to calculate input values 103 and 104. Furthermore, output value 151 only depends on intermediate values 141 and 142. Thus, the calculation for output value 151 can be performed simultaneously with the computations needed to calculate input values 103 and 104.

In some embodiments, a packetized system is used to create individual fragments of work such that each individual work fragment can be dispatched as soon as the required input data is available. In this manner, individual work fragment can be created for the calculations needed to create intermediate value 141, intermediate value 142, and output value 151. Those work fragments can be executed as long as input values 101 and 102 are available and in parallel with the calculations needed to create input values 103 and 104. An example of a packetized system is disclosed in the U.S. Patent Application with Ser. No. 17/970,450 filed on Oct. 20, 2022 titled “METHOD AND APPARATUS FOR USING A PACKET ARCHITECTURE TO PROCESS NEURAL NETWORKS IN A NEURAL PROCESSING UNIT”, and is hereby incorporated by reference. The teachings of this document are ideally implemented in such a system in order to best exploit the parallelism inherent in the neural networks being processed.

### Example Matrix Processor Circuit

As illustrated with reference to FIGS. 1A, 1B, and 1C, artificial intelligence relies upon large amounts of very computationally intensive matrix operations in order to initially learn using training data to adjust the weights in the weight matrices. Later, those adjusted weight matrices are used to perform complex matrix computations with a set of new input data to draw inferences upon the new input data. Fortunately, the linear algebra matrix operations used in an artificial neural network allow for many performance optimizations to be made since there is a significant amount of parallelism in the matrix computational tasks that are required. Thus, many specialized processors for artificial intelligence applications have been created. These specialized AI processors may use a Single Instruction Multiple-Data (SIMD) architecture wherein wide data vectors are processed with each instruction such that matrix operations can be performed efficiently.

To provide optimal processing for artificial intelligence tasks, specialized Matrix Processor may be used. A Matrix Processor is digital processing circuit that has been designed to help efficiently perform artificial intelligence computational tasks. Specifically, a Matrix Processor is designed in a manner to rapidly read input data vectors, output data vectors, and matrix weight data in parallel format for high throughput. In this manner, the Matrix Processor can be used for forward propagation inferences as well as for backpropagation artificial intelligence learning.

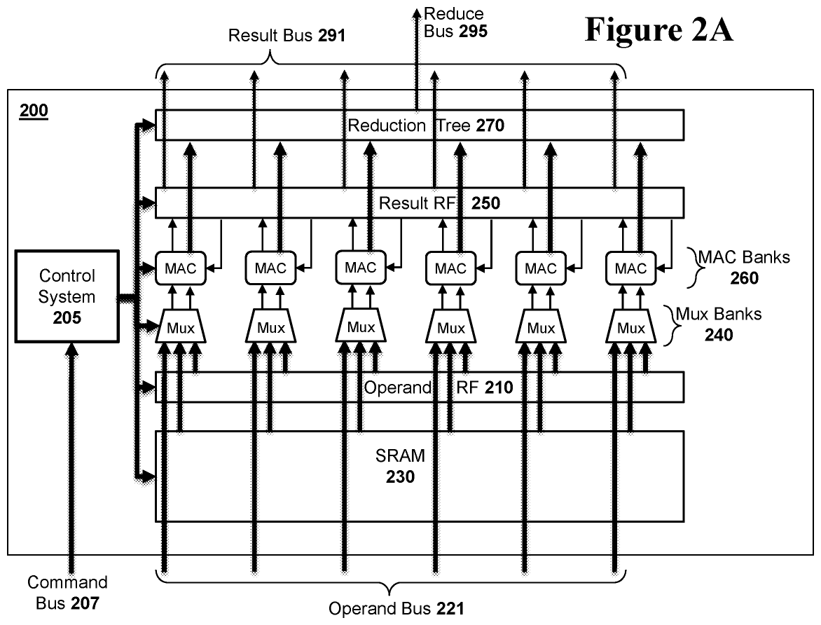

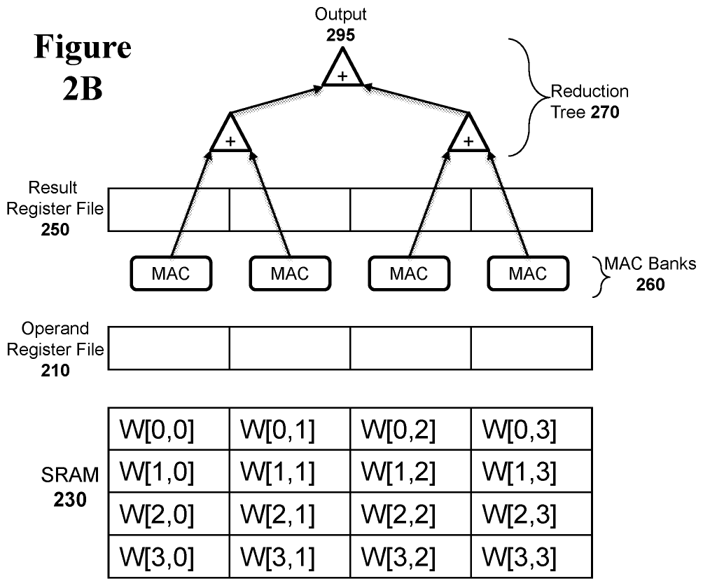

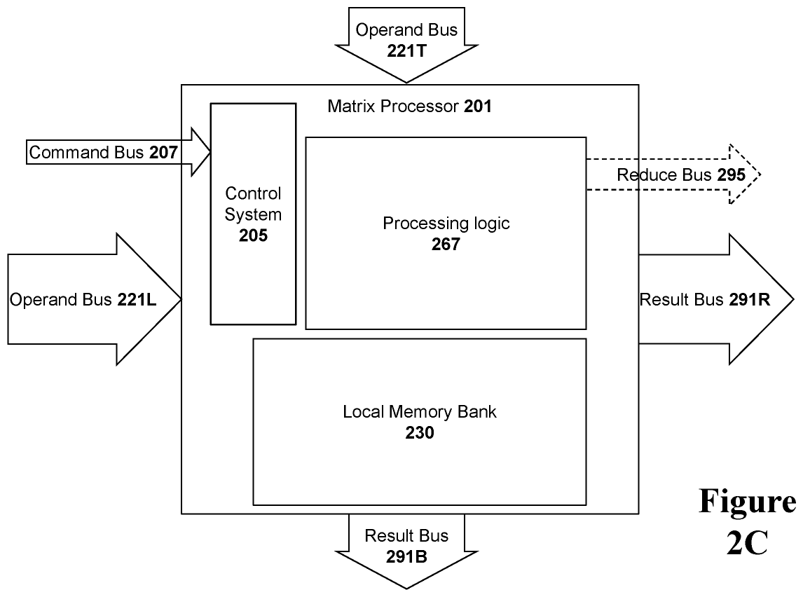

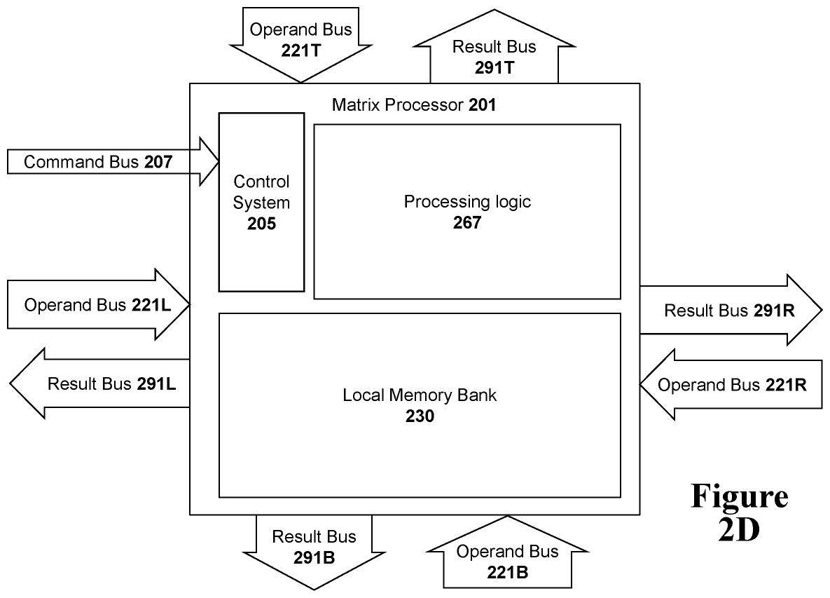

FIG. 2A illustrates a block diagram of one embodiment of an example matrix processor circuit 200. Note that matrix processor circuits can be made to handle data vectors with many more or fewer data elements in each data vector.

The matrix processor circuit 200 of FIG. 2A includes a local wide Static Random Access Memory (SRAM) bank 230. The SRAM bank 230 may be configured such that entire wide rows of data can be accessed in a single memory cycle. In this manner, an entire input data vectors or an entire row of weight values from a weight matrix may be read out from the SRAM bank 230 or written to the SRAM bank 230 in a single memory cycle. The matrix processor circuit 200 also includes an operand register file 210 for storing input data vectors and other data vectors that may be used as operands during computations.

The wide SRAM bank 230, the operand register file 210, and an operand bus 221 are coupled to a bank of multiplexors 240 that provide operand data to a bank of Multiply and Accumulate (MAC) units 260. A local control system 205 within the matrix processor circuit 200 controls all these individual circuit elements to perform the required data vector processing operations. Thus, local control system 205 selects between data stored within the wide SRAM 230, data in the operand register file 210, and data an operand bus 221 to be provided to the Multiply and Accumulate (MAC) units 260 for data vector processing.

Calculation output results from the bank of Multiply and Accumulate (MAC) units 260 may be stored in result register file 250. These output results may be output from in raw form in parallel using result bus 291. Alternatively (or in addition to the raw output data), the results in the result register file 250 may be combined with reduction tree 270 to provide a single output on reduce bus 295. Note that the reduction tree 270 may be implemented outside of the matrix processor circuit 200.

Note that for some operations the results stored in the result register file 250 may be used as an input operand in a subsequent data vector calculation. To handle such calculations, there are data paths from the result register file 250 back to bank of Multiply and Accumulate (MAC) units 260. Local control system 205 is used to control exactly how the Multiply and Accumulate (MAC) units 260 will select the input data to be processed and how the input data will be processed by the Multiply and Accumulate (MAC) units 260.

FIG. 2B conceptually illustrates how a four by four weight matrix consisting of elements W[0,0] to W[3,3] may be stored within the wide SRAM bank 230. Note that the weight values in the weight matrix are stored in alignment with the underlying SRAM 230 memory's row structure such that entire rows of weight values can be read out of the wide SRAM bank 230 in a single memory cycle. For example, weight values W[0,0], W[0,1], W[0,2], and W[0,3] from a first row in a weight matrix may be read out of wide SRAM bank 230 in a single memory cycle and provided simultaneously to the individual Multiply And Accumulate (MAC) units in the MAC bank 260 in parallel. The other input operands for a computation may come in parallel from the operand register file 210 or from the operand bus (not shown in FIG. 2B) to the MAC bank 260.

The matrix processor circuit 200 of FIGS. 2A and 2B illustrates only one possible embodiment of a matrix processor circuit. Details of the matrix processor circuit 200 of FIGS. 2A and 2B can be found in the U.S. patent application Ser. No. 16/149,054 and titled “Methods and Apparatus for Constructing Digital Circuits for Performing Matrix Operations” which is hereby incorporated by reference. However, matrix processor circuits can be implemented in many different manners and in many different sizes.

### Abstracted Matrix Processor Circuit

Matrix processor circuits can be implemented in many different sizes and in many different manners. However, to further efficiently process matrix operations, multiple matrix processor circuits may be combined together in efficient manners such that a controlled network of matrix processor circuits can perform a wide variety of matrix operations. Thus, to simplify this disclosure an abstracted matrix processor circuit will be disclosed with reference to FIG. 2C.

FIG. 2C illustrates a first block diagram of an example abstracted processor circuit 201. The abstracted matrix processor circuit 201 receives input data on one or more operand buses. In the particular embodiment of FIG. 2C, there are two operand buses: operand bus from the top 221T and operand bus 221L from the left. Data received on the operand buses may be used directly by the processing logic 267 or may be stored in memory bank 230 for later usage. The data received may comprise weight matrix data, input data operand vectors, or other data. The memory bank 230 may also include register files closely coupled to the processing logic 267. Note that operand and result buses may be placed on all of the different sides of the matrix process array circuit. FIG. 2D illustrates an example that has operand buses (221T, 221B, 221L, and 221R) and result buses (291T, 291B, 291L, and 291R) on all sides.

Referring back to FIG. 2C, the matrix processor circuit 201 also receives commands on command bus 207. The control system 205 within the matrix processor circuit 201 parses the commands received and uses the commands to determine how the processing logic 267 will be used to process data. The processing logic 267 maybe implemented in many different manners as long as the matrix processor 201 performs the desired matrix operations and outputs the proper matrix operation results. For example, the processing logic 267 may be implemented with a single-instruction multiple-data (SIMD) processor, a digital signal processor (DSP), a conventional central processing unit (CPU) core, a highly parallelized specialized matrix processor circuit 200 as illustrated in FIGS. 2A and 2B, or in any other manner that performs the desired matrix operations.

The abstracted matrix processor circuit 201 may be designed to operate using many different types of data formats and data precision levels. For example, the abstracted matrix processor circuit 201 may process integers, 16-bit floating point numbers, 32-bit floating point numbers, or any other data format. Many different matrix operations may be implemented in the abstracted matrix processor circuit 201. Two well-known matrix operations that may be included are the matrix dot product and the matrix cross products.

The control system 205 instructs the processing logic 267 to output the results of requested matrix operations on one or more result bus 291. In some embodiments, the matrix processor 205 will include the reduction logic output a reduced form of the result on a reduce bus 295. As will described later, reduction logic may also be implemented outside of the of the abstracted matrix processor circuit 201.

The operand buses 221T and 221L may be parallel buses such that entire input data vectors may be loaded into the abstracted matrix processor circuit 201 in a single cycle. Similarly, entire weight matrix rows from a weight matrix may be read into the memory bank 230 of the abstracted matrix processor circuit 201 in a single cycle. Similarly, the result buses 291R and 291B may parallel buses such that entire output data vectors can be output from the abstracted matrix processor circuit 201 in a single cycle.

As set forth earlier, the memory bank 230 of the abstracted matrix processor circuit 201 may be wide and deep to optimize performance. The memory bank 230 may be wide in that entire data vectors can be written into or read out of the memory bank 230 in a single cycle. For example, in a large matrix processor circuit 201 that handles a 16-by-16 element matrix wherein each element is a 16-bit floating-point value, the memory bank 230 may be configured to read out 256-bit values such that entire sixteen element data vectors of 16-bit data values each can be read out of the memory bank 230 in a single cycle.

The memory bank 230 may be constructed large enough to store multiple different sets of weight matrices. In this manner the matrix processor circuit 201 can used to perform matrix operations for multiple different artificial neural network layers without having to reload different matrix weight values. For example, if a matrix processor circuit 201 cannot perform an operation for one particular neural network layer because a required input data vector is not yet available, that matrix processor circuit 201 can instead be used to perform matrix operations for other neural network layers or for other neural networks. And as noted earlier, the operations of a neural network layer may be divided into individual work fragments such that some fragments units for later layers may be executed before work fragments from earlier layers as long as the required input data is available. A deep memory bank 230 allows the matrix processor 201 to be used very efficiently since it can handle a steady stream of requested matrix operations for many different neural networks without ever needing to load in new weight matrix data. Loading in weight matrix data can be one of the most time consuming (and energy consuming) tasks for a matrix processor circuit 201.

In addition to storing weight values for multiple different weight matrices, the memory bank 230 can be used to store other information that may be needed such as input data vectors, output data vectors, error vectors, etc. Intermediate result data vectors from forward pass operations may be stored in the memory bank 230 and then later accessed when performing a related back propagation operation. Another very important type of data that may be stored in the memory bank 230 is matrix weight gradients. A matrix weight gradient comprises a matrix of adjustments for a weight matrix that may be periodically used to update the weight matrix.

Combining Matrix Processors into an Array The abstracted matrix processor circuit 201 illustrated in FIG. 2C can

be used alone to perform simple matrix operations very quickly. For example, the matrix processor circuit 201 can be used to fully process the very small artificial neural network illustrated in FIG. 1A. It could also be used to implement the small three-layer artificial neural network illustrated in FIG. 1B by using it serially to perform the required matrix calculations of all three artificial neural network layers 121, 122, and 123.

However, most artificial neural networks must handle much larger data input vectors and output vectors than the very small example artificial neural networks illustrated in FIGS. 1A and 1B. It is therefore desirable to combine the computing ability of many different matrix processor circuits 201 in order process wider artificial neural networks and multi-layer artificial neural networks. In this manner, much larger multi-layer artificial neural networks that are used to perform useful artificial intelligence tasks can be handled very efficiently.

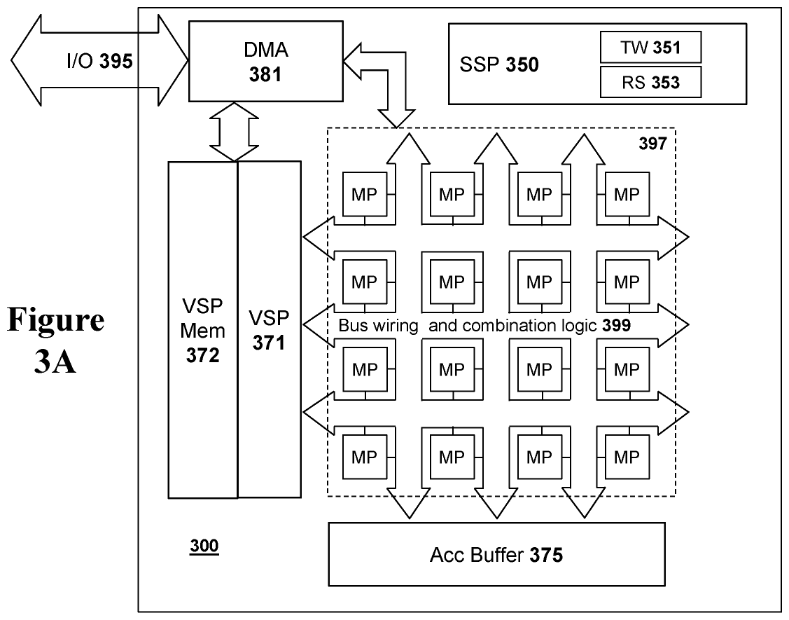

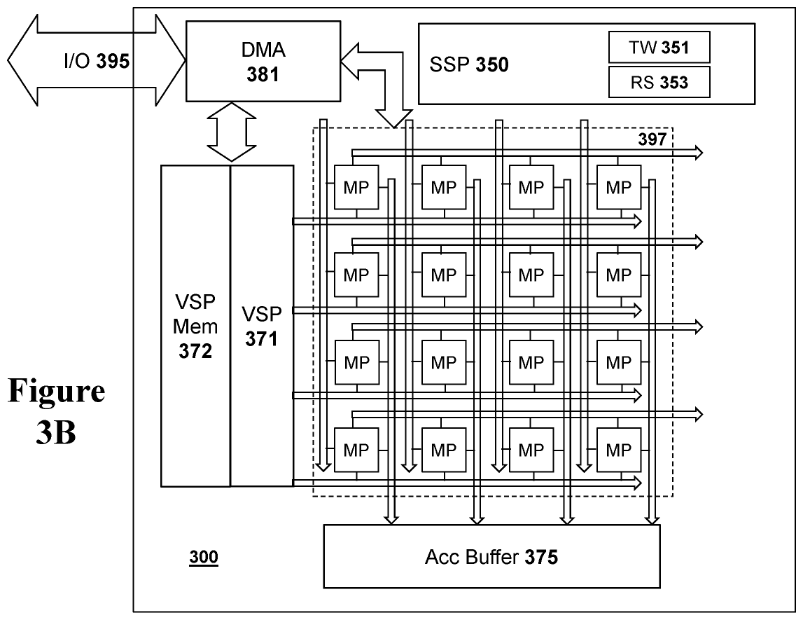

FIG. 3A illustrates a block diagram of a first embodiment of an architecture using multiple matrix processor circuits in a coordinated matter to efficiently process wide multi-layer artificial neural networks. In FIG. 3A, each individual matrix processor circuit is labelled as “MP” for matrix processor. As illustrated in the example of FIG. 3A, the matrix processor circuits are arranged in a grid array format. In between the individual matrix processor circuits of the matrix processor array is bus wiring and combination logic 399 that couples all the individual matrix processor circuits in the array to buffers that carry input data vectors, matrix weight values, and result data vectors. The array of matrix processors and the bus wiring and combination logic 399 may be referred to as a matrix processor array 397. The bus wiring and combination logic 399 may be implemented in different manners to achieve different goals.

To provide input data vectors to the matrix processor array 397 in one embodiment, a Vector Scalar Processor (VSP) 371 is coupled to an operand bus of every individual matrix processor circuit in the array bus wiring 399. This may be accomplished by coupling operand bus 221L as illustrated in FIG. 2C. In this manner, data vectors can be loaded into the individual matrix processor circuits in the array. The data vectors may comprise weight matrix rows, input data vectors, or any other required data for the processing operations to be performed. Note that since there are multiple buses, these data vector loading operations can be performed in parallel.

Similarly, the result bus of every individual matrix processor circuit in the array is coupled to an accumulation buffer (Acc Buffer) 375 on the bottom of the matrix processor array 397 using bus wiring and combination logic 399. This may be accomplished by coupling result bus 291B of FIG. 2C to Accumulation Buffer 375 (Acc Buffer) on the bottom as illustrated in FIG. 3A. The Accumulation Buffer 375 contain both storage for storing result data vectors and processing logic for performing various vector processing operations on received result data vectors. For example, the Accumulation Buffer 375 can combine partial result data vectors from multiple different matrix processor circuits into a single complete output data vector result.

All of the individual matrix processor circuits in the matrix processor array 397 receive commands on their individual command buses. In this manner, each individual matrix processor circuits in the array can be controlled individually. For example, the individual matrix processor circuits can be informed when input data is available on their operand buses and what operations to perform. Thus, work fragments from different parts of the same neural network layer or from different network layers may be executed concurrently by different matrix processor circuits. By carefully controlling each individual matrix processor circuit in the matrix processor array 397 in a coordinated manner, the matrix processor array 397 becomes a very powerful system for efficiently processing many work fragments of matrix operations in parallel for neural network applications. Specifically, the matrix processor array 397 along with all the supporting circuitry (Accumulation Buffer 375, Vector Scalar Processor (VSP) 371, Direct Memory Access (DMA) unit 381, etc.) may be referred to as a Neural Processing Unit (NPU) 300.

### Neural Processing Unit External Data Management Overview

To process neural networks within the matrix processor array 397 of FIG. 3A, the Neural Processing Unit (NPU) 300 must receive data from an external source. As illustrated in FIG. 3A, there is an Input/Output (I/O) interface 395 for the Neural Processing Unit (NPU) 300 controlled by a Direct Memory Access (DMA) 381 that can receive and send data from outside of the Neural Processing Unit (NPU) 300. To operate most efficiently, the Neural Processing Unit (NPU) 300 must use its various internal memories and the external data sources coupled to Input/Output interface 395 as efficiently as possible. Ideally, the Neural Processing Unit (NPU) 300 of FIG. 3A will generally have the data that it needs to perform matrix computations stored in internal local memories as frequently possible such that processing can occur without interruption. When accesses to external data sources over Input/Output (I/O) interface 395 are made, such external access operations should be made as rarely as possible and as efficiently as possible. Thus, the Neural Processing Unit (NPU) 300 should try to keep important data that will be reused within the internal memories until it is no longer needed.

### Neural Processing Unit Overview

Referring to FIG. 3A, the Neural Processing Unit (NPU) 300 is controlled by a Scheduler & Sequence Processor (SSP) 350. The Scheduler & Sequence Processor (SSP) 350 is responsible for sending all the cycle commands to the vector scalar processor (VSP) 371, all the various individual matrix processor (MP) circuits within matrix processor array 397, and the Accumulation Buffer 375. (Connections not shown for clarity.)

The Scheduler & Sequence Processor (SSP) 350 may include a Tree Walker (TW) 351 and a Row Sequencer (RS) 353. The Tree Walker (TW) 351 walks a neural network tree and is responsible for obtaining the data slices needed for processing. The Row Sequencer (RS) 353 may not just handle one row at time, it can combine multiple rows into a single row sequence. The Row Sequencer (RS) 353 responsible for implementing all the cycle commands for each data slice. Every operating cycle each vector scalar processor (VSP) 371 follows the received cycle commands. The same is true for the matrix processors within the matrix processor array 397, the Accumulation Buffer 375, and the Direct Memory Access (DMA) unit 381. Every resource needs to be carefully sequenced for the Neural Processing Unit (NPU) 300 to operate properly. Thus, a set of cycle commands needs to be generated for each operating cycle.

The Direct Memory Access (DMA) unit 381 may issue multiple requests in parallel. This document will use the term Direct Memory Access (DMA) unit which may be used to access external DRAM memory. However, the DMA unit 381 should be considered a generic memory access system that may be used to access any different type of memory system (DRAM, SRAM, flash memory) with any type of memory interface (serial memory bus, network access, parallel bus, etc.). Additional information about the DMA unit 381 will be provided in a later section.

A computer system may use many Neural Processing Units 300 within artificial intelligence computer system. Different Neural Processing Units may be controlled in a manner to cooperate on the same neural network problem. (Alternatively, a single Neural Processing Unit may be partitioned into multiple areas and process completely different computational problems simultaneously within the same Neural Processing Unit.) When several different Neural Processing Units are cooperating on the same computational problem, the DMA system 381 may be used transfer data from one Neural Processing Unit to another Neural Processing Unit. This allows different Neural Processing Unit to address different stages or layers of the same neural network computational problem.

The matrix processor array 397 responsible for processing convolutions and fully connected (FC) neural network layers. The matrix processor array 397 can also do groupwise convolutions. The matrix processor array 397 may perform two-dimensional reuse. First dimension is input data broadcast wherein data is broadcast from the Vector Scalar Processor (VSP) 371. There may be partial summation units within the bus wiring and combination logic 399 that can combine data values on the way to the Accumulation Buffer 375.

The Accumulation Buffer 375 is responsible of accumulation of results from various different matrix processors in the matrix processor array 397. The Accumulation Buffer 375 may also perform quantization. The Accumulation Buffer 375 may also perform activation functions for a neural network. For example, the ReLU (Rectified Linear Unit), PRELU (Parametric ReLU), Leaky ReLU, and other well-known activation functions may be performed within the Accumulation Buffer circuitry 375. (Some activation functions can be performed in vector scalar processor (VSP) 371 as well.)

The vector scalar processor (VSP) 371 is responsible for other computations not performed within the matrix processor array 397 or Accumulation Buffer 375. The vector scalar processor (VSP) 371 can perform pooling functions such as the Max pool and average pool functions. The vector scalar processor (VSP) 371 can also perform data reshape functions. For example, for example data can be changed from one format to another in order to increase or decrease the precision of data. The vector scalar processor (VSP) 371 has its own dedicated memory 372 illustrated as a memory block to the left of the vector scalar processor (VSP) 371.

Each matrix processor (MP) in the matrix processor array 397 includes its own local memory (as shown as local memory bank 230 in FIG. 2D). This local matrix processor memory is mainly used for storying neural network weights. (Note that matrix weights can also be loaded just in time from the vector scalar processor (VSP) 371 but to reduce power consumption and memory port bandwidth usage, the matrix weights are often stored within the local matrix process memory. This local storage of matrix weights allows the reuse those matrix weights as much as possible. The local matrix processor memory may also be used for storing temporary results.

### Neural Processing Unit Data Access.

The Neural Processing Unit 300 of FIGS. 3A and 3B sends and receives data from outside of the Neural Processing Unit 300 using the Direct Memory Access (DMA) 381 coupled to an Input/Output port 395. Note that this document will specifically refer to “Direct Memory Access” usage. However, the term Direct Memory Access in this document can apply to any movement of data outside of the Neural Processing Unit 300. For example, the DMA unit 381 may access memory on a different integrated circuit die or it may access memory from a different partitioned area of the same integrated circuit chip.

In one embodiment, the Direct Memory Access system (DMA) 381 will be used to access a high-speed memory system such as an external Double Data Rate (DDR) memory system. However, all the disclosed techniques related to the accessing of data outside of the Neural Processing Unit 300 apply to any type of interface system for accessing data and for accessing any type of data storage system. For example, the external interface system 395 of the DMA unit 381 may comprise a Peripheral Component Interconnect Express (PCIe) bus to obtain data. Similarly, the external interface system 395 may comprise a Mobile Industry Processor Interface (MIPI) data bus. Another data bus type of interface is the Advanced extensible Interface (AXI) data bus that is commonly used with ARM (Advanced RISC Machine) based processor systems.

Beyond just computer data bus systems, the techniques can be used to access any computer network system to access external data. For example, the Direct Memory Access (DMA) system 381 may access the well-known Ethernet interface to access data available on a computer network. Alternatively, the DMA system may access data stored on the same chip using on-chip data fabric. For example, as set forth earlier, a chip may include multiple different Neural Processing Units 300 that cooperate together to perform neural network processing tasks. Thus, the Direct Memory Access (DMA) system 381 may use the on-chip data fabric to transfer data between different Neural

Processing Units 300 on the same chip.

The Direct Memory Access (DMA) system 381 may operate with all different types of master and slave interface systems. With master types of interfaces, the master is in control of interface. Thus, with a master type of interface the DMA system 381 can initiate data transfers at any time. With a slave type of interface, the DMA system 381 can only initiate data transfers when the slave interface receives permission from the master of the interface system. The slave can issue a “indicate status” message to the master informing the master whether the slave can currently receive or send data. The master of the interface system may then inform the slave when the slave can send data such that the DMA system 381 on the slave interface can then respond with a transfer of data.

A master based external interface system will generally require less data buffering ability since the master has the ability to initiate data transfers as necessary. The slave interface may require more data buffering since the slave lacks control of the data interface and thus can only transfer data when the slave receives permission from the interface master to transfer data.

The Direct Memory Access (DMA) system 381 may implement data compression and data decompression in order to reduce the amount of memory used when storing data and the amount of memory bandwidth used when loading or storing data on the Input/Output port 395 that couples to external memory. This can be very useful when dealing with neural network weight matrices that can be quite large. Thus, when the Direct Memory Access (DMA) system 381 needs to store a weight matrix, the Direct Memory Access (DMA) system 381 will first compress the weight matrix such that bandwidth on the Input/Output port 395 and storage space in the external memory (not shown) are conserved. When the weight matrix is subsequently retrieved, the Direct Memory Access (DMA) system 381 will decompress the compressed weight matrix before usage.

Conventional Management Overview With a simple convolution neural network, current neural network

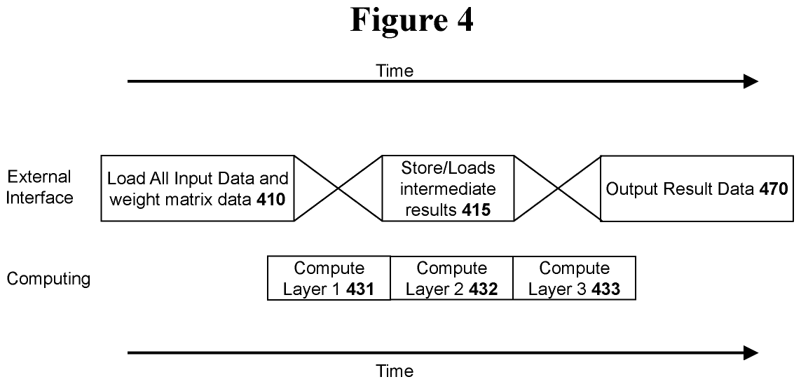

processing systems may operate in a very simple straightforward manner. To describe conventional neural network processing system operation, an example of processing the three-layer neural network illustrated in FIG. 1B will be presented with reference to FIG. 4.

Referring to FIG. 4, the first step is to load in all of the data needed for the desired calculations into the neural processing unit. This is illustrated on FIG. 4 as input data and weight matrix data 410 being loaded in on an external interface. When sufficient data has been loaded into the neural processing unit memory to begin calculations, the system can start processing tensor data. This is illustrated as the system processing Layer 1 431. During operation, the neural processing unit may store and reload intermediate results 415 to the external memory. The neural processing system then processes through all the convolution neural network layers as illustrated with Layer 2 432 and Layer 3 433 being processed until the full three-layer neural network is completely processed with a final output result. When output result data is available then the neural processing system can begin sending out the output result data as illustrated in FIG. 4 with output data 470 being sent out on the external interface.

There are several problems with this traditional system. One of the biggest disadvantages is that this is very wasteful of the input/output bandwidth available on the external I/O interface. Specifically, the system first uses the I/O bandwidth to load in the input data 410 but then the system largely allows the I/O bandwidth of the external interface to sit idle while the data is processed through all the neural network layers with the except of potentially storing intermediate results 415. After all the matrix computations of Layer 1 431, Layer 2 432, and Layer 3 433 the system then uses using the external interface to send out the final result data 470. Thus, in such a system the I/O bandwidth may need to be overprovisioned as an expensive high-speed interface in order to quickly load in source data and load out result data in order to minimize latency in such a system. And that high-speed external interface spends much of the time doing nothing.

Another disadvantage of the technique illustrated in FIG. 4 is that this is a very high latency solution. Specifically, the technique illustrated in FIG. 4 does very little to take advantage of the natural parallelism inherent in the computational problem. There is a small amount of parallelism in that the processing for layer 1 431 can begin before all of the input data 410 has been received and that the result output data 470 can begin to be sent out before completing the processing for the final layer (layer 3 433). But other than that, all of the processing operations performed in the system of FIG. 4 is done serially and thus this system has high latency.

One final additional problem with this traditional solution of FIG. 4 is that this traditional system requires large amounts of memory within neural processor unit for storing all of the input data, all of the matrix weight data, the intermediate results that are created during the neural processing, and the final output data. Thus, improvements would be desirable to improve performance and increase resource utilization efficiency.

Matrix Processor Array with Improved External Data Access.

To improve upon the traditional system, the present disclosure uses a data loading and storing techniques that more efficiently uses the external storage interface of the neural processing system. Specifically, the proposed system more fully utilizes the external storage interface bandwidth when loading in weight matrices. In this manner, the neural network processing latency may be reduced, resource utilization is improved, and power is conserved.

Three different types of data are mainly loaded and stored when performing neural network processing: matrix weight data, input data, and output data. In a typical neural network, the intermediate result data may be both output data from a current neural network layer and input data for a subsequent neural network layer. This disclosure presents techniques for improving data transfer efficiency for matrix weight data.

Tapering Weight Matrix Data into a Neural Processor

The weight matrix data represents a large amount of data that must be loaded into a neural processor in order to perform neural network calculations. One technique used by the disclosed system is to load in more than one set of weight matrices such that the neural processor can work on processing work fragments for the same layer, for several different neural network layers, or even for several different neural networks without reloading weight matrix data.

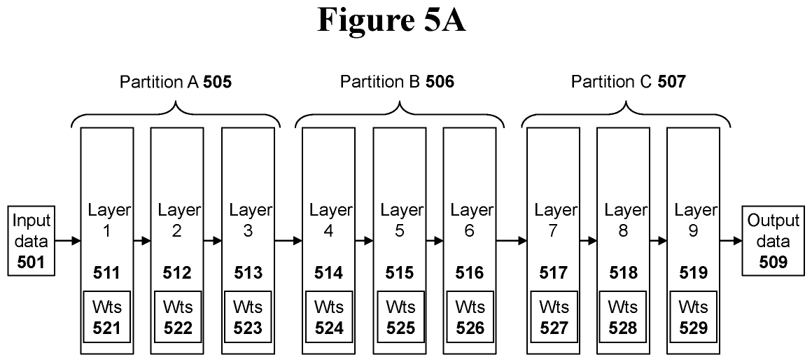

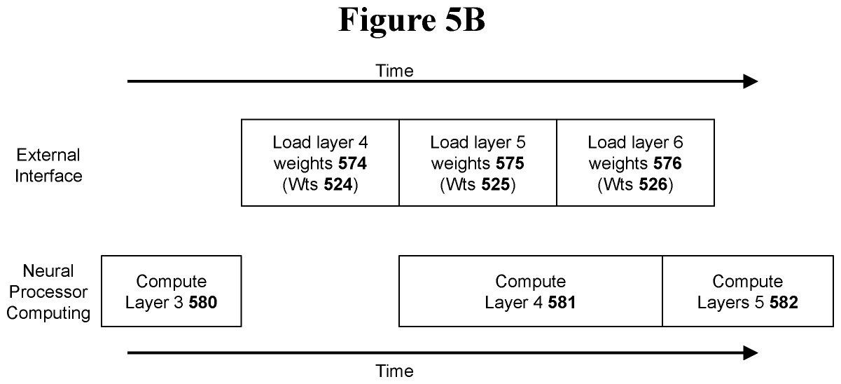

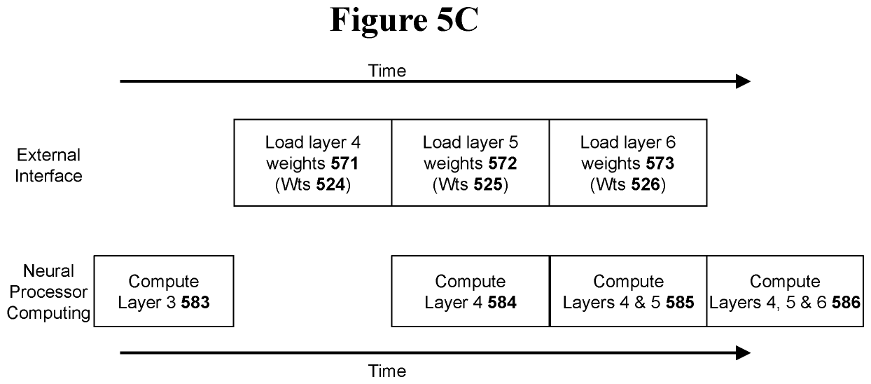

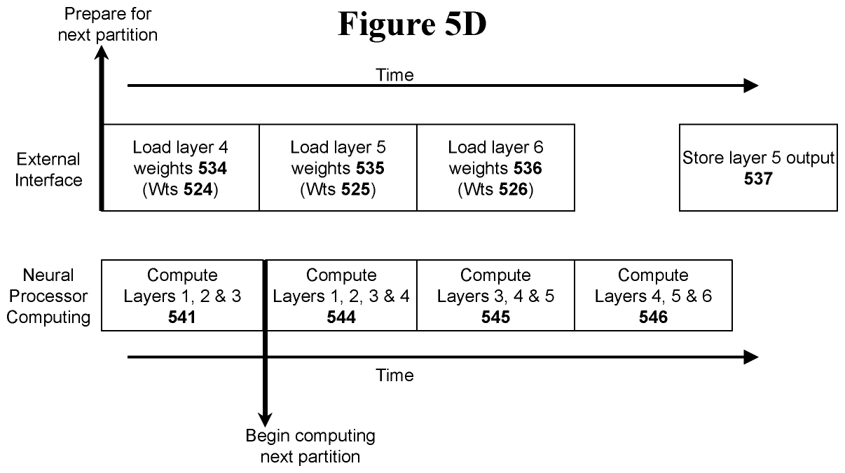

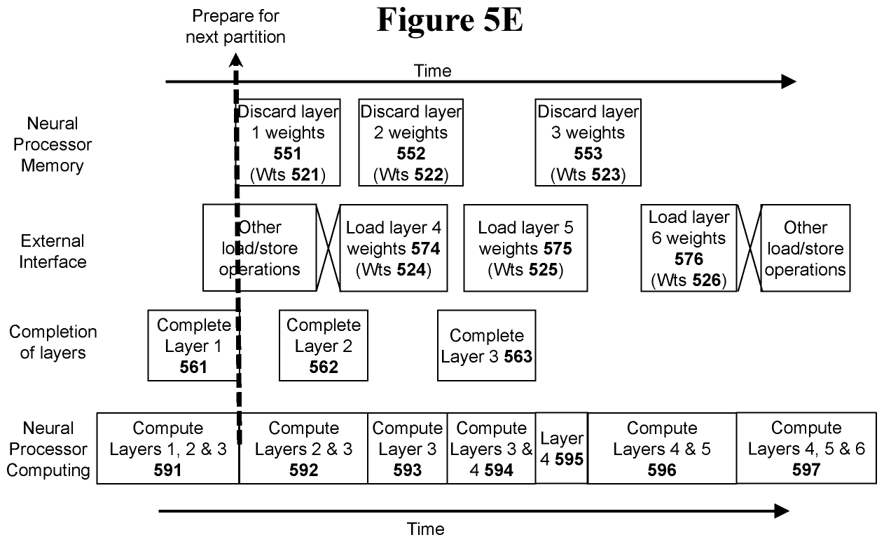

FIG. 5 conceptually illustrates a nine-layer neural network that receives a set of input data 501, processes that input data 501 through nine neural network layers (511 to 519), and outputs a set of result data 509. To reduce the loading and reloading of weight matrix data, the system may load in several sets of weight matrices and process several layers at a time. In the example of FIG. 5, the nine-layer neural network has been divided into three “partitions” of three neural network layers each: Partition A 505, Partition B 506, and Partition C 507. Each partition of neural network layers may be processed together as a group. Thus, work fragments from any of the layers in a partition may be processed as long as the required input data is available for the work fragment.

For example, to process Partition A 505, the neural processor loads in weight matrices 521, 522, and 523 to process neural network layer 1 511, neural network layer 2 512, and neural network layer 3 513, respectively. In this manner, the neural processor can process work fragments for neural network layer 1 511, neural network layer 2 512, and neural network layer 3 513 by only loading those weight matrices once. Note that in embodiments that use work fragments then work fragments from any of those three neural network layers can be processed as long as the needed input data for those work fragments are available. Thus, work fragments may be processed out of a traditional neural network processing order. As the system completes the processing for Partition A 505, the system can then load in the weight matrices (524, 525, and 526) for the next partition of neural network layers, Partition B 506, consisting of neural network layer 4 514, neural network layer 5 515, and neural network layer 6 516.

FIG. 5B illustrates a simple timing diagram of a method of how the next weight matrices may be loaded in a system that does not use work fragments and instead processes neural network layers one layer at a time. Referring to FIG. 5B, as soon as the final layer 3 computation 580 is done, the neural processor may then begin to load in the weight matrices for the three layers of Partition B 506 with load operations 574, 575, and 576 of weight matrices 524, 525, and 526, respectively. As soon as the layer 4 weights 524 are loaded, the system can begin the computations for layer 4 at stage 581. In this embodiment without work fragments, all the computations for layer 4 in stage 581 must be completed before the system begins computations for layer 5 at stage 582 The method illustrated in FIG. 5B may not use the computation circuitry efficiently since the available calculations to work on are limited to the one neural network layer being processed. For example, during stage 581 the system can only operate on layer 4 computations.

To use the available computation circuitry more efficiently, the use of work fragments allows the system to operate on computations from multiple different layers at the same time. FIG. 5C illustrates a timing diagram of a system that allows any work fragments from the same partition to be handled at the same time. Referring to FIG. 5C, as soon as the final layer 3 computation 583 is done, the neural processor may then begin to load in the weight matrices for the three layers of Partition B 506 with load operations 571, 572, and 573 of weight matrices 524, 525, and 526, respectively. As soon as the layer 4 weights 524 are loaded at stage 571, the system can begin the work fragments for layer 4 at stage 584. However, immediately after loading in the layer 5 weights 525 at stage 572, the system can then begin processing work fragments for both layers 4 and 5 at stage 585. Similarly, immediately after loading in the layer 6 weights 526 at stage 573, the system can then begin processing work fragments for all of the layers in partition B 506 (layers 4, 5, and 6) at stage 586. In this manner, the neural processor can more efficiently use the computation circuitry since more different work fragments may be selected for processing operations at stage 586. Thus, the neural processor will be less likely to stall due to not having a work fragment that is ready for computation.

Referring to FIGS. 5B and 5C, both systems wait until the previous partition of layers is complete before loading in weight matrices for the next partition. Thus, this method introduces some latency into the flow of neural network calculations. Specifically, this allows the neural processor to be idle as illustrated in the neural processor computing timeline in FIGS. 5B and 5C.

To operate more efficiently, this disclosure proposes preparing for the next partition of neural network layers before the current partition of neural network layers has completed processing. Referring to FIG. 5D, before the neural processor is complete with the computations of layers 1 to 3 of partition A 505, the neural processor begins to load the weight matrices for the next partition of neural network layers. Specifically, the external interface of the neural processor performs load operation 534 to load in layer 4 weights 524 of partition B 506 before partition A 505 has completed. In this manner, the neural processor can then immediately begin processing work fragments from layer 4 at stage 544 after the layer 4 weights 524 have been loaded into the neural processor. Note that the system may continue completing processing work fragments from partition A 505 (layers 1, 2, and 3) during stage 544.

Load operation 534 may then be followed by load operation 535 of layer 5 weights 525 and load operation 536 of layer 6 weights 526. In this manner, the neural processor can begin processing the rest of the work fragments in partition B 506. Specifically, after load operation 535 of layer 5 weights 525 is completed, the neural processor can then process any remaining work fragments from partition A 505 and work fragments for layers 4 and 5 during stage 545. Then after load operation 536 of the layer 6 weights 526, the neural processor can then process all work fragments for all of partition B 506 (layers 4, 5, and 6) during stage 546. Note that any work fragments left from partition A 505 may still be finishing up (not shown).

As can be seen in FIG. 5D, the neural processing timeline illustrates the neural processor not being idle since the weight matrices for the next partition are tapered into the neural processor before they are needed. In this manner, the neural processor always has work fragments that can be processed such that the utilization of the neural processor is greatly improved.

### Tapering Weight Matrix Data Out of a Neural Processor

In addition to maximizing neural processor utilization and efficiently using the interface to external memory by tapering in weight matrices, the system can also minimize memory usage and maximize utilization by tapering weight matrices out of the neural processor. In the technique of FIG. 5D described in the previous section, the neural processor loads in a new set of weight matrices while the existing set of weight matrices are still in the neural processor memory and thus uses up valuable memory resources within the neural processor. To improve on this, FIG. 5E illustrates an implementation wherein the neural processor tapers out weight matrices by discarding some weight matrices from a first partition before loading in new matrices for a following partition.

Referring to the timing diagram of FIG. 5E, as soon as the neural processor completes its last layer 1 computation 561 from partition A 505, the neural processor begins to prepare for the next partition of layers by discarding 551 layer 1 weights 521 since those weights are no longer needed. This frees up memory space for load operation 574 to load in layer 4 weights 524. During this time, the neural processor continues processing work fragments for layers 2 and 3 of partition A 505 at stage 592.

As layer 2 512 is completed at stage 562, the system also discards the layer 2 weights 522 at stage 552. During this time, the system may be will be finishing up work fragments from layer 3 at stage 593. However, once the layer 4 weights 524 are loaded, the neural processor can then process work fragments from layer 3 513 of partition A 505 and layer 4 514 of partition B 506 at stage 594. Note that due to the neural processor is able to process work fragments from two different partitions (partition A 505 and partition B 506) as it tapers out weight matrices from the first partition and tapers in weight matrices from a following partition. After the layer 2 weights 522 are discarded at stage 552 the system loads in the layer 5 weights 525 at stage 575. Note that memory may be conserved by not loading in new weights until previously used weights are discarded.

Around the same time the system may complete work fragments for layer 3 at stage 563 and thus discard the layer 3 weights 523 at stage 553. The system can then begin a load operation of layer 6 weights 526 at stage 576. Note that after discarding the layer 3 weights 523 at stage 553 the system will be working on work fragments for layer 4 514 of partition B 506 at stage 595. But as soon the layer 5 515 weights 525 become available after the load operation 575, the neural processor may then process work fragments for layers 4 and 5 at stage 596. Finally, when the layer 6 weights 526 of partition B 506 become available after the load operation 576, the neural processor may then process any of the work fragments from partition B 506 (work fragments for layers 4, 5, and 6) at stage 597 such that a smooth transition from partition A 505 to partition B 506 has been completed without stalling or idling the neural processor as illustrated by the neural processor computing timeline on the bottom of FIG. 5E.

Instead of taking the time to discard previously needed weight matrices, the neural processor may further optimize operation by immediately loading new weight matrices into the memory locations previously occupied by weight matrices that are no longer needed. In such a highly optimized embodiment, no additional memory is required at all since the neural processor tapers in new weight matrices into the memory locations of the previous weight matrices. Specifically, the new loaded matrices are placed in the same memory location of the discarded matrices.

A neural processor may have context switches where it switches between different neural network processing jobs. During such context switches, the techniques hereby disclosed for tapering weight matrices in and out of the neural processor may be used to maximize utilization during such context switches.

Prefetching Weight Matrix Data into a Neural Processor

Referring back to FIGS. 5D and 5E, the loading of weight matrix data for a partition of neural network layers can consume a significant bandwidth on the external memory interface. If the neural processor always waits until right before a switch to a new partition before loading in weight matrices needed for the new partition, there may be too much traffic on external memory interface such that needed weight matrices are not loaded before those weight matrices are needed. This can cause a stall or idling of the neural processor. To prevent this from occurring, weight matrices may be prefetched into the neural processor whenever there bandwidth available on the external memory interface. This will consume some memory in the neural processor but can help guarantee that the neural processor will not stall or have its matrix processors sit idle.

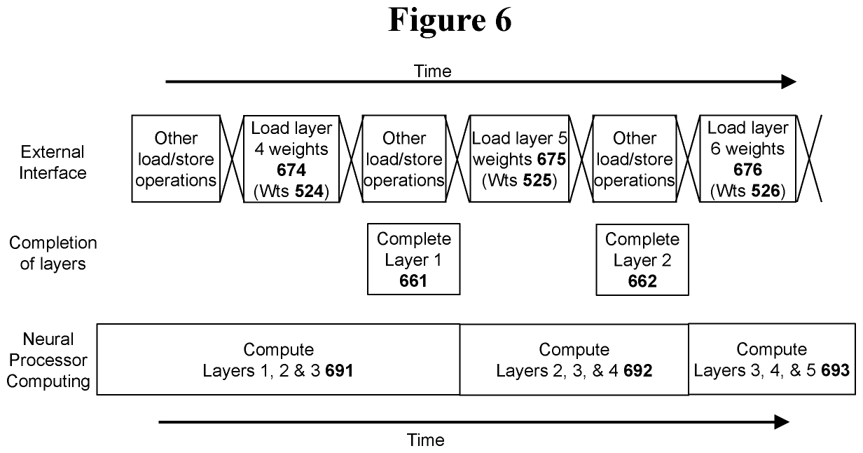

FIG. 6 illustrates a timing diagram illustrating how weight matrices may be prefetched into a neural network processor. Initially, the neural network processor is processing layers 1, 2, and 3 at stage 691. During this processing, the external interface is being used for many different types of load and store operations. However, the neural network processor can also issue a load operation for a layer for weight matrix. When there is available bandwidth on the external interface, the system will issue load layer 4 weights operation 674 to load in the layer 4 weights 524. These weights can be stored in the neural processor until they needed.

When the neural processor completes layer 1 of the first partition, the neural processor might decide to start using the layer 4 weights. Thus, after the neural processor completes layer 1 at stage 661, the neural processor may switch from processing layers 1, 2, and 3 during stage 691 to processing layers 2, 3, and 4 during stage 692.

During all this time load and store operations will be happening on the external interface. And when there is free bandwidth on the external interface, the DMA unit may issue load operation 675 to load in the layer 5 weights 525. Again, these weights will be stored until the neural processor decides to start processing work fragments from layer 5. Again, this may be triggered by completing a previous layer. Thus, at stage 662 the neural processor completes layer 2 work fragments and then begins processing layers 3, 4, and 5 during stage 692.

As illustrated in the timing diagram of FIG. 6, prefetching allows the memory bandwidth consuming task of loading in large weight matrices to be performed on an opportunistic basis. For example, weight matrix prefetches can be done on a lower priority basis. In this manner, the external memory bandwidth usage can be optimized.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim is still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. § 1.72 (b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

We claim:

1. A method of processing a multilayer neural network with a neural network processor by tapering in weight matrix data from a memory coupled to said neural network processor, said method comprising the steps of:
dividing said multilayer neural network into subsets of neural network layers wherein each subset will be processed as a group; each said subset of neural network layers referred to as a partition;
dividing each neural network layer of each said partition into a set of work fragments, each work fragment comprising a subset of computations for said neural network layer;
grouping set of said work fragments of each partition into work fragment subsets that can be processed simultaneously;
loading into said neural network processor a first work fragment subset for a first partition from said memory;
loading in a first subset of weight matrix data from said external memory for said first work fragment subset of said first partition into said neural network processor;
commencing processing of said first work fragment subset when said first subset of weight matrix data is available;
loading in a second subset of weight matrix data from said external memory, if not already loaded, for a second work fragment subset for said first partition into said neural network processor while processing said first work fragment subset for said first partition;
loading said second work fragment subset for said first partition into said neural network processor from said external memory; and
processing said second work fragment subset for said first partition, when said second subset of weight matrix data for said second work fragment subset is available.

2. The method of processing a multilayer neural network with a neural network processor and managing access to a memory as set forth in claim 1 wherein said work fragment subsets contain work fragments from different neural network layers in said first partition.

3. The method of processing a multilayer neural network with a neural network processor and managing access to a memory as set forth in claim 1 wherein work fragments may be processed out of order such that a later neural network layer may be processed before an earlier neural network layer.

4. The method of processing a multilayer neural network with a neural network processor and managing access to a memory as set forth in claim 1 further comprising:
decompressing said first subset of weight matrix data loaded from said external memory.

5. The method of processing a multilayer neural network with a neural network processor and managing access to a memory as set forth in claim 1 wherein said first subset of weight matrix data may comprise one of several different data precisions.

6. The method of processing a multilayer neural network with a neural network processor and managing access to a memory as set forth in claim 1 further comprising:
reloading in said first subset of weight matrix data from said external memory after a context switch of said neural network processor.

7. A method of processing a multilayer neural network with a neural network processor and tapering out weight matrix from said neural network processor, said method comprising the steps of:
dividing said multilayer neural network into subsets of neural network layers wherein each subset will be processed as a group; said subsets of neural network layers referred to as partition;
dividing each network layer in each partition into a set of work fragments;
grouping set of said work fragments of each cut into work fragment subsets that can be processed simultaneously;
loading into said neural network processor a first work fragment subset for a first partition from said external memory;
loading in a first weight matrix from said external memory for said set of work fragments layers of said first partition;
commencing processing of said work fragments for said neural network layers of said first partition;
discarding said first weight matrix for a first neural network fragment of said first partition after processing a final work fragment for said first network layer to free memory resources; and
loading a second weight matrix for a neural network layer in a subsequent partition into said neural network processor while completing processing of said work fragments of said first partition.

8. The method of processing a multilayer neural network with a neural network processor and tapering weight matrix data from said neural network processor as set forth in claim 7, said method further comprising:
decompressing said first weight matrix loaded from said external memory.

9. The method of processing a multilayer neural network with a neural network processor and managing access to a memory as set forth in claim 7 wherein said first weight matrix may comprise one of several different data precisions.

10. The method of processing a multilayer neural network with a neural network processor and managing access to a memory as set forth in claim 7 further comprising:
reloading in said first weight matrix from said external memory after a context switch of said neural network processor.

11. The method of processing a multilayer neural network with a neural network processor and managing access to a memory as set forth in claim 7 wherein said partitions can belong to different neural networks.

12. A method of processing a multilayer neural network with a neural network processor and prefetching weight matrix data from an external memory, said method comprising the steps of:
dividing said multilayer neural network into subsets of neural network layers wherein each subset will be processed as a group; said subsets of neural network layers referred to as partition;
dividing each network layer in each partition into a set of work fragments;
grouping set of said work fragments of each partition into work fragment subsets that can be processed simultaneously;
loading into said neural network processor a first work fragment subset for a first partition from said external memory;
loading in a first weight matrix from said external memory for said set of work fragments layers of said first partition;
commencing processing of said work fragments for said neural network layers of said first partition;
prefetching a second weight matrix for a neural network layer in a subsequent partition from said external memory into said neural network processor while processing of said work fragments of said first partition when memory bandwidth is available to said external memory; and
storing said second weight matrix in said neural network processor until said subsequent partition is triggered and said second weight matrix is needed for processing.

13. The method of processing a multilayer neural network with a neural network processor and prefetching weight matrix data from an external memory as set forth in claim 12 wherein said prefetching is performed with a lower priority than other accesses to said external memory.

14. The method of processing a multilayer neural network with a neural network processor and prefetching weight matrix data from an external memory as set forth in claim 12 wherein said partitions can belong to different neural networks.

15. The method of processing a multilayer neural network with a neural network processor and prefetching weight matrix data from an external memory as set forth in claim 12 wherein said work fragments can be executed out of order.

16. The method of processing a multilayer neural network with a neural network processor and prefetching weight matrix data from an external memory as set forth in claim 12 wherein said partitions can belong to different neural networks.

17. The method of processing a multilayer neural network with a neural network processor and tapering weight matrix data out from said neural network processor as set forth in claim 12, said method further comprising:
decompressing said second weight matrix prefetched from said external memory.
